(19) United States
(12) Patent Application Publication
(10) Pub. No.: US 2013/0162811 A1
(43) Pub. Date: Jun. 27, 2013

(54) METHOD FOR TESTING LIGHT-EMITTING DIODES USING DIGITAL IMAGES

(71) Applicants: Jeff SONG, Taipei (TW); Tsai-Fa Wang, Taipei (TW)

(72) Inventors: Jeff SONG, Taipei (TW); Tsai-Fa Wang, Taipei (TW)

(21) Appl. No.: 13/435,640

(22) Filed: Mar. 30, 2012

(30) Foreign Application Priority Data
Dec. 21, 2011 (TW) 100147795

(51) Int. Cl. H04N 7/18

(52) U.S. Cl. 348/93; 348/92; 348/E07.085

(57) ABSTRACT

A method for detecting light-emitting diodes using digital images to check whether each light-emitting diode in a to-be-detected computer is normal or not, the method includes shooting a default image for at least one light-emitting diodes in a default computer; selecting one diode as a first initial light source; obtaining default location information according to the locations of the contiguous light-emitting diodes relative to the first initial light source; similarly obtaining light signal information according to the locations of the light-emitting diodes relative to a second initial light source which corresponds to the first initial light source, and comparing the light signal location information with the default location information to judge whether the light-emitting diodes are in normal work.

### CROSS-REFERENCE TO RELATED APPLICATIONS

This non-provisional application claims priority under 35 U.S.C. §119(a) on Patent Application No(s). 100147795 filed in Taiwan, R.O.C. on Dec. 21, 2011, the entire contents of which are hereby incorporated by reference.

### BACKGROUND

1. Technical Field

The disclosure relates to a testing method using digital image, and more particularly to a method for testing light-emitting diodes using digital images.

2. Related Art

With the improvement of computation capability of a computer, various technical fields increasingly depend on computers. When a computer performs data visit to a storage device, network connection, or programs, light-emitting diodes on the backplane of a computer is drove to emit light in different ways. For example, when a computer uploads/downloads data onto/from a network, the light-emitting diode on the interface card of the computer alternately flashes. Specifically, orange light and green light alternatively flash. In such a way, users can clearly know that whether the interface card of the computer is in normal operation.

Therefore, the light signal of various types of light-emitting diodes should be tested during the manufacture process of computers. In the related art, workers along the production lines usually check the light signals of the light-emitting diodes by their eyes. When computers on a conveyor are carried to workers, these workers have to judge whether the shining status of the light-emitting diodes of the computers are normal or not in a limited time period. Generally, light-emitting diodes are arranged in arrays in order to be viewed easily. As a result, due to visual fatigue, workers may misjudge the shining status of some light-emitting diodes.

In order to overcome the above drawbacks, manufacturers have proposed a device for automatically detecting light-emitting diodes. According to the known testing device, each light-emitting diode is connected to one end of an optical fiber, and the other end of the optical fiber is connected to the testing device. Thus, the shining status of a light-emitting diode can be detected due to the optical fiber.

Since there are many light-emitting diodes, workers have to connect all light-emitting diodes to their corresponding optical fibers, and thus human cost and time are taken more than those of the visual check.

### SUMMARY

The present disclosure provides a method for detecting light-emitting diodes using digital images, including the following steps: shooting a default image for at least one light-emitting diodes in a default computer by an image capturing unit; selecting one from the light-emitting diodes in the default image and defining the selected one as a first initial light source; visiting one by one light-emitting diodes contiguous to the first initial light source by means of short path first and recording locations of the contiguous light-emitting diodes relative to the first initial light source; outputting default location information according to the locations of the contiguous light-emitting diodes relative to the first initial light source; shooting a light signal image for the to-be-detected computer by the image capturing unit, selecting a second initial light source from the light signal image according to location of the first initial light source in the default image, and visiting light-emitting diodes contiguous to the second initial light source by means of short path first; outputting light signal information according to the locations of the light-emitting diodes relative to the second initial light source; comparing the light signal location information with the default location information to judge whether the light-emitting diodes are in normal work; and outputting an error message if the light signal location information is not in accordance with the default location information.

### BRIEF DESCRIPTION OF THE DRAWINGS

The present disclosure will become more fully understood from the detailed description given herein below for illustration only, and thus are not limitative of the present disclosure, and wherein:

FIG. 1 is a schematic illustration for the architecture of the present disclosure;

FIG. 2 is a schematic illustration for a flowchart for information setting according to the present disclosure;

FIG. 3 is schematic illustration for visiting paths to light-emitting diodes according to the present disclosure;

FIG. 4 is a flowchart for the detecting method according to the present disclosure;

FIG. 5A is a schematic illustration for the default location information according to the present disclosure; and

FIG. 5B is a schematic illustration for the light signal location information according to the present disclosure.

### DETAILED DESCRIPTION

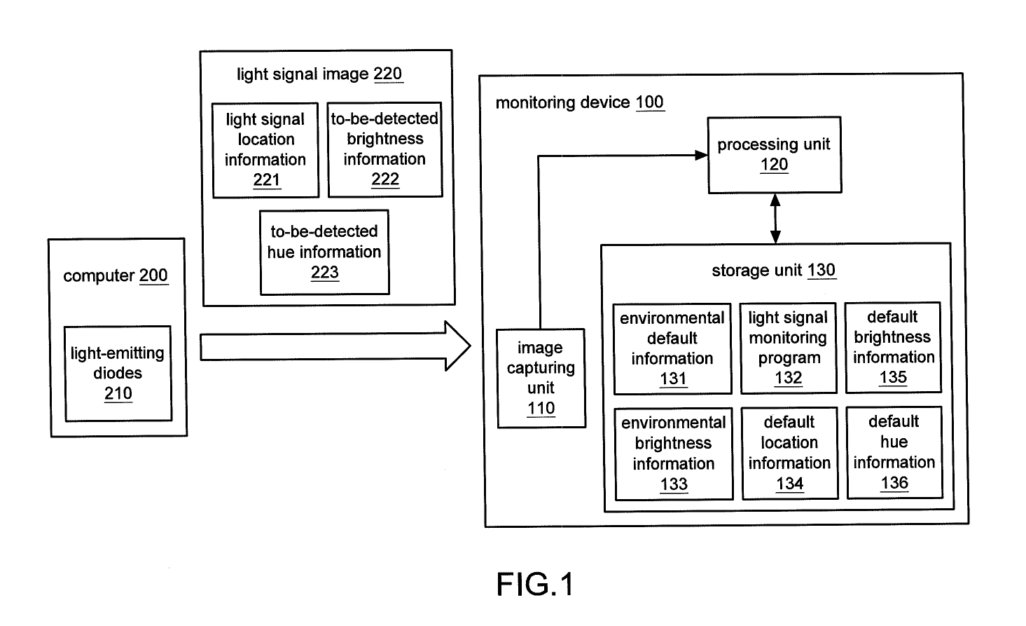

The computer of the present disclosure may be a personal computer, a notebook, and a server. FIG. 1 is a block diagram of an embodiment of the present disclosure. With reference to FIG. 1, there are a monitoring device 100 and a computer 200. The computer 200 comprises at least one light-emitting diode. The flashing manner, color, and brightness of a light-emitting diode depend on the types of products, but are not limited to the description of the present disclosure.

The monitoring device 100 comprises an image capturing unit 110, a processing unit 120, and a storage unit 130. The processing unit 120 is electrically connected to the storage unit 130 and the image capturing unit 110. The image capturing unit 110 shoots digital images. The image capturing unit 110 may be, but is not limited to, a webcam, a digital camera, or a camcorder. The image capturing unit 110 may be a built-in component of the monitoring device 100, or may be connected to the image capturing unit 100 by a cable or wireless connection. The storage unit 130 is configured to store environmental default information 131 as well as a light signal monitoring program 132.

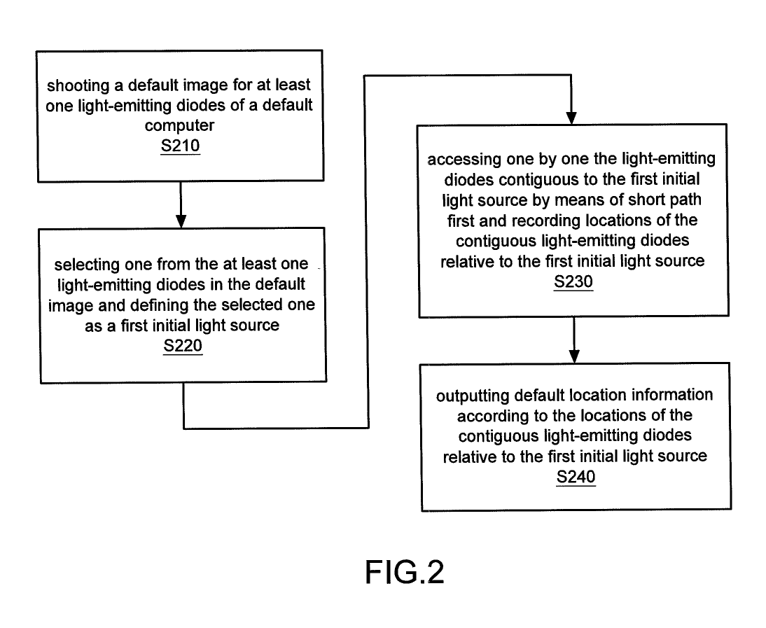

The processing unit 120 needs to execute the following programs before executing the light signal monitoring program 132 so as to obtain the environmental brightness information 133. FIG. 2 is a flowchart for information setting according to an embodiment of the present disclosure. The processing unit 120 obtains the environmental default information 131 by the following steps:

In Step S210, a default image for at least one light-emitting diodes of a default computer is captured;

In Step S220, one of the at least one light-emitting diodes in the default image is selected and the selected light-emitting diode is defined as a first initial light source;

In Step S230, the light-emitting diodes contiguous to the first initial light source is visited along a shortest path first and locations of the contiguous light-emitting diodes relative to the first initial light source are recorded; and

In Step S240, default location information of the locations of the contiguous light-emitting diodes relative to the first initial light source is output.

Users can shoot an image for the computer 200 using various shooting parameters. The computer 200 is defined as the default computer which is adapted to be compared with a computer to be detected, wherein the computer to be tested is defined as a to-be-detected computer. The default image and the shooting parameters of the default image are recorded in the environmental brightness information 133 by the monitoring device 100. The shooting parameters are, for example, photosensitivity value, aperture value, and shutter speed. The monitoring device 100 can select one image from a plurality of images shoot as the default image by using edge detection or brightness detection. Alternatively, users themselves can perform the above selection.

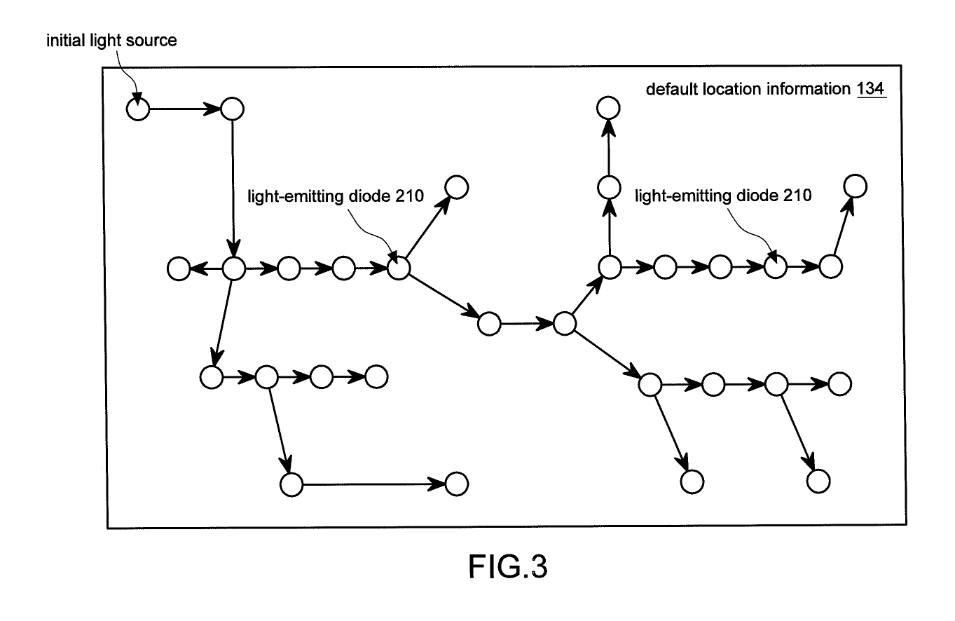

The processing unit 120 selects one from all light-emitting diodes as the first initial light source. The processing unit 120 then visits contiguous light-emitting diodes 210 by topology from the first initial light source, and consequently establishes default location information 134 according to paths of visiting the light-emitting diodes. The establishment of the default location information 134 can be clearly understood with reference to FIG. 3. The symbol [symbol] in FIG. 3 represents a light-emitting diode 210.

It is assumed that the processing unit 120 selects the light-emitting diode 210 at the top left corner of FIG. 3 as an initial light source. The processing unit 120 searches the contiguous light-emitting diodes 210 from the initial light source. Two light-emitting diodes respectively at the right side and at the right bottom of the initial light source are found. If using the visiting order of short path first, the light-emitting diode at the right side of the initial light source is firstly visited. Arrows in FIG. 3 represent visiting paths. Similarly, the next light-emitting diode to be visited is determined by the visiting order of short-path-first method. The processing unit 120 also records relative locations of the visited light-emitting diodes when visiting each diode. The locations of the contiguous light-emitting diodes can be deduced based on two-dimensional coordinates. Finally, the processing unit 120 not only records all the relative locations into the default location information 134, but also records the brightness values of all light-emitting diodes in brightness information 135.

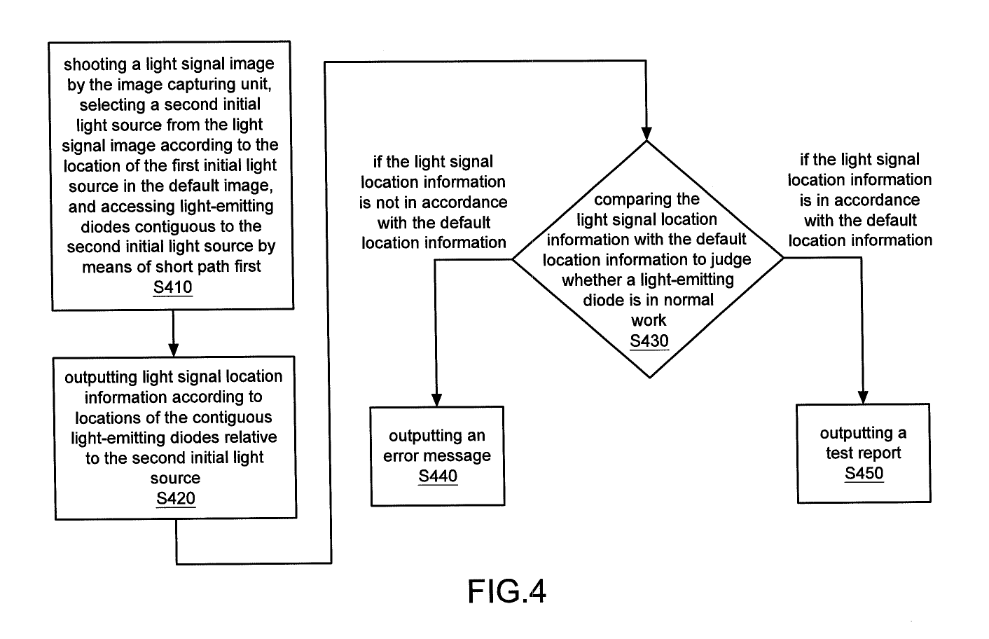

After obtaining the default location information 134 and the default brightness information 135, the monitoring device 100 may test the to-be-detected computer correspondingly. FIG. 4 is a flowchart for the testing method according to the present disclosure. With reference to FIG. 4, the processing unit 120 implements the detecting method by the following steps:

In Step S410, a light signal image is shot by the image capturing unit, a second initial light source is selected from the light signal image according to the location of the first initial light source in the default image, wherein the location of the second initial light source in the light signal image is the same as that of the first initial light source in the default image. The light-emitting diodes contiguous to the second initial light source are visited by means of short path first.

In Step S420, light signal location information according to locations of the contiguous light-emitting diodes relative to the second initial light source is output;

In Step S430, the light signal location information is compared with the default location information to judge whether a light-emitting diode is in normal operation;

In Step S440, an error message is output if the light signal location information is not in accordance with the default location information.

In Step S450, if the light signal location information is in accordance with the default location information, a test report is output by the monitoring device, wherein the test report records that the computer has passed the light signal test for light-emitting diodes.

The processing unit 120 loads the default location information 134 and the environmental brightness information 133 from the storage unit 130 and then performs the default location information 134 and the environmental brightness information 133. The processing unit 120 then adjusts the shooting parameters of the image capturing unit according to the environmental brightness information 133. As described above, the environmental brightness information 133 records photosensitivity value, aperture value, and shutter speed of the image capturing unit 110. Thus, the image capturing unit 110 use the same shooting parameters as those recorded in the environmental brightness information 133 to shoot the light signal image 220. In the present disclosure, the digital image shoot here is referred as light signal image 220. The light signal image 220 is used to record light-emitting diodes 210 of the computer 200.

Then, the processing unit 120 records relative locations of light-emitting diodes 210 into light signal location information 221 according to the light signal image 220, so as to determine locations of the light-emitting diodes 210. Furthermore, the manner for recording the light signal location information 221 may be based on the above described visiting order of the short-path-first method. After obtaining the light signal location information 221 of the light signal image 220, the processing unit 120 compares the light signal location information 221 and the default location information 134, and thus determine whether the location of each light-emitting diode in the default computer is in accordance with that in the to-be-detected computer. After loading the default location information 134, the processing unit 120 will find in the light signal image 220 the corresponding location of the second initial light source which is corresponding to the location of the first initial light source in the default location information 134. After obtaining the second initial light source in the light signal image 220, the processing unit 120 visits all light-emitting diodes 210 according to the default location information 134.

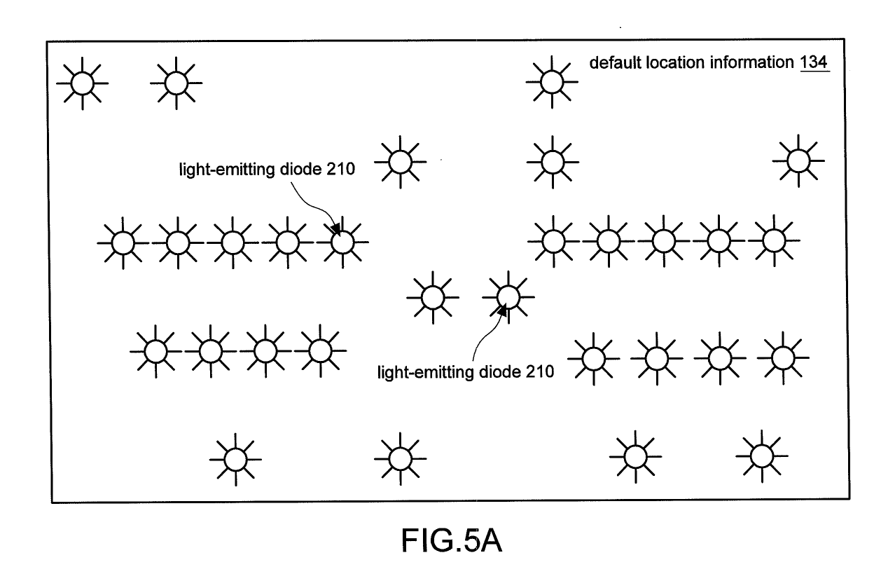

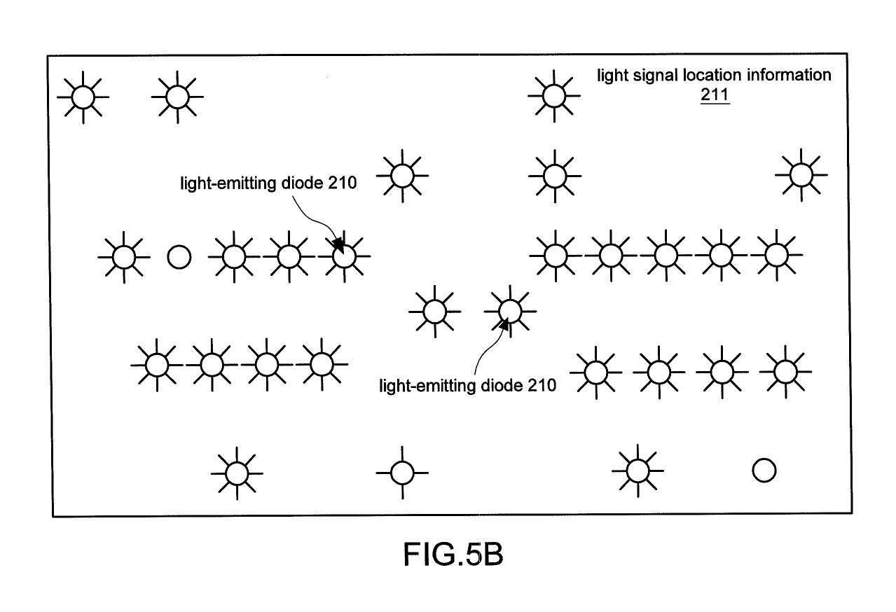

If the light signal location information 221 is not in accordance with the default location information 134, the processing unit 120 may output an error message by a displayer or an alarm device so as to inform users that there might be a problem in light signal display or the type of the to-be-detected computer. For instance, FIG. 5A and FIG. 5B respectively show the locations of light-emitting diodes 210 according to the default location information 134 and according to the light signal location information 221. In FIGS. 5A and 5B, [symbol] represents a shining light-emitting diode 210 while [symbol] represents a un-shinning light-emitting diode 210. During the process of visiting each light-emitting diode 210, the processing unit 120 can learn whether a light-emitting diode is in normal operation according to the light signal in the light signal image 220. If the processing unit 120 cannot visit a light-emitting diode 210 in the corresponding location (i.e., the light-emitting diode in the corresponding location is not shining or there is not a light-emitting diode in the corresponding location), the process unit 120 will record the light-emitting diode 210 failed to be visited into the error message.

After the visiting process, the fact that all light-emitting diodes pass the detection means two cases: one is that the to-be-detected computer is in normal work, and the other is that there might be a problem in brightness or displaying color of a light-emitting diode in the to-be-detected computer although the light-emitting diode can shine normally.

The present disclosure provides another variation of the above first case. The processing unit 120 records brightness values of light-emitting diodes 210 of the default computer when recording locations of these light-emitting diodes. After achieving the default location information, default brightness information is also outputted with the default location information. During the monitoring device 100 detecting the to-be-detected computer, the processing unit 120 may detect not only whether a light-emitting diode can shine normally but also brightness value of the light-emitting diode.

With obtaining the work status of light-emitting diodes of the to-be-detected computer, the processing unit 120 record brightness values of these light-emitting diodes in to-be-detected brightness information. Furthermore, the processing unit 120 can compare the brightness of a light-emitting diode in the to-be-detected computer with that of a light-emitting diode at the same location in the default computer, according to default brightness information and the to-be-detected brightness information.

The brightness of a light-emitting diode 210 can be obtained from an image after a hue conversion. Generally, after selecting the default image or the light signal image, the processing unit performs a color range conversion to the selected image. The digital image shoot by the image capturing unit 110 is a color image shown by three primary colors, i.e., red, green and blue. The color image includes other image objects except for light-emitting diodes. In order to differentiating light-emitting diodes 210 from other objects, the default image is converted into a black and white image by changing its hue, saturation, and brightness. The disclosure can judge brightness difference according to black and white images. The processing unit may determine whether the brightness difference is too large according to the default brightness information 135 of the default image and the to-be-detected brightness information 222 of the light signal image 220.

As for the second case, the present disclosure judges whether colors of all light-emitting diodes are identical. Similarly, when capturing the default image, the processing unit 120 may record the brightness of each light-emitting diode 210. In this embodiment, the processing unit 120 may perform a hue conversion to light-emitting diodes in the default image or in the light signal image. The processing unit 210 then captures the hue image after the conversion to be the color representation of the light-emitting diodes.

In the steps of recording the locations of the light-emitting diodes relative to the first initial light source, the processing unit 120 records colors of the light-emitting diodes in default hue information 136. In the steps of recording the locations of the light-emitting diodes relative to the second initial light source, the processing unit 120 records colors of the light-emitting diodes in to-be-detected hue information 223. When comparing the light signal location information with the default location information, the processing unit 120 loads the default hue information and compares it with the to-be-detected hue information 223.

The method for detecting light-emitting diodes using digital images according to the present disclosure may be implemented by an independent image capturing unit 110 which shoots the light signal image 220 for the computer 200. The present disclosure does not need to equip an optical fiber detection device for the computer 200, and also can avoid problems, such as misjudgment of light signal due to visual check error.

What is claimed is:

1. A method for detecting light-emitting diodes using digital images to check whether each light-emitting diode in a to-be-detected computer is normal or not, the method comprising:
shooting a default image for at least one light-emitting diodes in a default computer by an image capturing unit;
selecting one of the light-emitting diodes in the default image and defining the selected light-emitting diode as a first initial light source;
visiting one by one light-emitting diodes contiguous to the first initial light source by means of short path first and recording locations of the contiguous light-emitting diodes relative to the first initial light source;
outputting default location information according to the locations of the contiguous light-emitting diodes relative to the first initial light source;
shooting a light signal image for the to-be-detected computer by the image capturing unit, selecting a second initial light source from the light signal image according to location of the first initial light source in the default image, and visiting light-emitting diodes contiguous to the second initial light source by means of short path first;
outputting light signal information according to the locations of the light-emitting diodes relative to the second initial light source;
comparing the light signal location information with the default location information to judge whether the light-emitting diodes are in normal work; and
outputting an error message if the light signal location information is not in accordance with the default location information.

2. The method according to claim 1, wherein the image capturing unit further comprises a shooting parameter which is photosensitivity value, aperture value, or shutter speed.

3. The method according to claim 1, wherein the step of recording locations of the contiguous light-emitting diodes relative to the first initial light source further comprises:
recording brightness values of the light-emitting diodes in default brightness information.

4. The method according to claim 3, wherein the step of recording locations of the contiguous light-emitting diodes relative to the second initial light source further comprises:
recording brightness values of the light-emitting diodes in to-be-detected brightness information.

5. The method according to claim 4, wherein the step of comparing the light signal location information with the default location information further comprises:
loading the default brightness information; and
comparing the default brightness information with the to-be-detected brightness information to judge whether brightness values of the light-emitting diodes are identical.

6. The method according to claim 4, wherein the step of recording locations of the contiguous light-emitting diodes relative to the second initial light source further comprises:
recording colors of the light-emitting diodes in to-be-detected hue information.

7. The method according to claim 4, wherein the step of comparing the light signal location information with the default location information further comprises:
loading the default hue information; and
comparing the default hue information with the to-be-detected hue information to judge whether colors of the light-emitting diodes are identical.

8. The method according to claim 1, wherein the step of recording locations of the contiguous light-emitting diodes relative to the first initial light source further comprises:
recording colors of the light-emitting diodes in default hue information.

9. The method according to claim 1, wherein if the light signal location information is in accordance with the default location information, outing a test report.
